(19) United States
(12) Patent Application Publication
(10) Pub. No.: US 2024/0271057 A1
(43) Pub. Date: Aug. 15, 2024

(54) SEPARATION PROCESS

(71) Applicant: Cargill, Incorporated, Wayzata, MN (US)

(72) Inventor: Rob DEKKER, Delfgauw (NL)

(21) Appl. No.: 18/565,275

(22) PCT Filed: Jun. 3, 2022
(86) PCT No.: PCT/US2022/032096

§ 371 Date: Nov. 29, 2023

(30) Foreign Application Priority Data
Jun. 4, 2021 (EP) 21177755.2

(51) Int. Cl. C11B 3/12; A23G 1/36; C11B 7/00

(52) U.S. Cl. CPC C11B 3/12; A23G 1/36; C11B 7/0075

(57) ABSTRACT

Present invention relates to a palm oil separation process comprising the following steps: step a) subjecting a palm oil starting material to short-path evaporation to obtain a distillate and a palm retentate: and step b) subjecting the palm retentateobtained in step a) to a dry fractionation step to obtain a stearin fraction and an olein fraction. Present invention further relates a soft palm mid fraction or a hard palm mid fraction obtainable by the process according to the invention and to a fat composition comprising the hard palm mid fraction and a StOSt-rich fat. In addition, the invention relates to a confectionary product such as chocolate, a chocolate-like product, cocoa-based fillings and cocoa-based coatings. The invention also relates to the use of the fat composition as a cocoa butter equivalent. The aim of the invention is to increase the yield and purify of the stearin and olein fractions obtained.

### CROSS-REFERENCE TO RELATED APPLICATIONS

This application claims the benefit of European Patent Application No. 21177755.2, filed 4 Jun. 2021, which is hereby incorporated by reference in its entirety.

### FIELD OF THE INVENTION

The present invention relates to a novel separation process for obtaining stearin and olein fractions of a palm oil starting material. The present invention also relates to soft and hard palm mid fractions, a fat composition comprising this and the use of the fat composition as well as to a confectionary product comprising the hard palm mid fraction.

### BACKGROUND OF THE INVENTION

For the fractionation of palm oil, two main processes exist, i.e. solvent fractionation and dry fractionation.

Solvent fractionation is a process in which palm oil is melted in a suitable solvent yielding olein and stearin fractions. A disadvantage of solvent fractionation is that the process requires large investments to ensure safe operation (due to the large amounts of solvents needed) as well as high amounts of energy and costs are involved. An advantage of solvent fractionation is that high quality palm oil fractions, especially solid palm fractions, such as a soft palm mid fraction or a hard palm mid fraction, e.g. suitable for use in a cocoa butter equivalent (CBE), are obtained.

Dry fractionation is a process in which palm oil is melted and then crystallized using a specific cooling process. The term “dry fractionation” is used to refer to a fractionation process for palm oil in which crystallization is used to separate the fractions, no solvents are used. A stearin fraction is obtained by cooling down melted oil to a temperature whereby a slurry of partly crystallized and partly liquid oil is obtained. The solid fat crystals are subsequently removed from the liquid oil by filtering, e.g. membrane filtering.

A disadvantage of dry fractionation is that there is a more difficult separation of solid fat crystals and liquid oil. As a consequence, the quality of the obtained fractions is usually less (more liquid oil remaining in the stearin fraction) than the stearin and olein fractions obtained by the process of solvent fractionation. However, dry fractionation has also some important advantages. Since no solvent is used, dry fractionation is a process that is safer to operate and requires less investment than solvent fractionation. Also, the operational cost for the dry fractionation process is considerably lower than for solvent fractionation because the recovery of high amounts of solvent consumes high amounts of energy and therefore costs.

US2017/107446 A1 discloses a fatty acid composition comprising greater than 60 wt. % of stearic acid, from 3 to 30 wt. % of oleic acid and less than 10 wt. % of palmitic acid. The composition may be used in the preparation of a triglyceride. CN111280281A discloses a fat composition and method for the preparation thereof, in particular to a chocolate fat composition. Long et al., European Journal of Lipid Science Technology, 2005, vol. 107, no. 10, pages 754-761 disclose a process for separating crude olein fractions into low-melting super olein and high-melting soft stearin having low DAG content. Pudel et al., European Journal of Lipid Science Technology, 2015, vol. 118, no. 3, pages 396-405 disclose short path distillation to produce edible oils low in MCPD compounds and GE with comparable quality to conventionally deodorized oils.

There is thus a need for an improved process for obtaining stearin and olein fractions using dry fractionation of palm oil so that no solvent is used during the process, and which results in an improved quality of the obtained fractions. The present invention addresses this need. The present invention is particularly aiming at palm mid fractions, such as soft palm mid fraction (soft PMF) and hard palm mid fraction (hard PMF). It is an aim of the present invention to obtain a high quality hard PMF that can be used in CBE (cocoa butter equivalent, being a fat that is fully compatible with cocoa butter and it has chemical and physical properties similar to those of cocoa butter).

### STATEMENTS OF THE INVENTION

The present invention thus provides in a first aspect a separation process comprising the following steps, in order: step a) subjecting a palm oil starting material to short-path evaporation at a pressure below 1.0 mbar and at a evaporator temperature of at least 230° C. to obtain a distillate and a palm retentate: the palm oil starting material being selected from the group consisting of palm oil, palm olein, palm stearin, soft stearin, soft palm mid fraction and any combination of two or more thereof: and step b) subjecting the palm retentate obtained in step a) to a dry fractionation step to obtain a stearin fraction and an olein fraction: wherein the process optionally further comprises: step c) subjecting the stearin fraction or the olein fraction obtained in step b) to a further dry fractionation step to obtain further fractions: and wherein the process optionally further comprises: step d) of subjecting the stearin fraction or the olein fraction obtained in step b) or further fractions of step c) to a bleaching and/or deodorization step.

The advantage of the present process is that it provides high quality palm fractions without the need for solvent fractionation. In other words, it increases the quality of the fractions obtained in view of a standard dry fractionation process by the addition of a step preceding the dry fractionation.

In an instance of the process, the invention relates to a process comprising: step a) subjecting a soft palm mid fraction (IV (iodine value) 42-48) to a short-path evaporation at a pressure below 1.0 mbar, at a temperature of at least 230° C. and at a feed rate per unit area of evaporator surface of the shorth-path evaporation equipment in a range of from 5 to 180 kg/h·m² to obtain a distillate and a palm retentate: and step b) subjecting the palm retentate obtained in step a) to a dry fractionation step to obtain an olein fraction and a hard palm mid fraction (IV 31 and 36). By way of example, the obtained olein fraction can have an IV of 45-51. This specific process starts with a soft palm mid fraction to obtain a high quality hard palm mid fraction that is suitable for use in CBE.

In another instance of the process, the invention relates to a process comprising: step a) subjecting a palm olein (IV 54-59) to a short-path evaporation at a pressure below 1.0 mbar, at a temperature of at least 230° C. and at a feed rate per unit area of evaporator surface of the shorth-path evaporation equipment in a range of from 5 to 180 kg/h·m² to obtain a distillate and a palm retentate: and step b) subjecting the palm retentate obtained in step a) to a dry fractionation step to obtain an olein fraction and a soft palm mid fraction (IV 42-48): and step c) subjecting the soft palm mid fraction obtained in step b) to a further dry fractionation step to obtain an olein fraction and a hard palm mid fraction (IV 31-36). This specific process starts with a palm olein to obtain a high quality hard palm mid fraction that is suitable for use as a component in CBE. By way of example, the obtained olein fraction in step b) can have an IV of 60-66.

In another aspect, the invention relates to the soft palm mid fractions obtainable or directly obtained by the inventive process.

The invention further relates to a soft palm mid fraction having: i) an iodine value in the range of 42 to 48: ii) a S2U content in the range of 70 wt. % to 80 wt. %, preferably in the range of 72 wt. % to 78 wt. %; iii) a DAG (diglyceride, also called a diacylglycerol) content of less than 3.0 wt. %; iv) a content of MCPD compounds content of less than 1 ppm: and v) preferably an S3 content of less than 6 wt. %, more preferably less than 5 wt. %. These soft palm mid fractions are of high quality and are suitable for adding to a confectionary product or as a starting material for obtaining hard palm mid fractions.

In another aspect, the invention relates to the hard palm mid fractions obtainable or directly obtained by the inventive process.

The invention further relates to a hard palm mid fraction having: i) an iodine value IV 31-36; ii) a S2U content in the range of 80 wt. % to 95 wt. %, preferably in the range of 85 wt. % to 90 wt. %; iii) a DAG content of less than 3.0 wt. %; and iv) a content of MCPD compounds of less than 1 ppm. These hard palm mid fractions obtained are of high quality. They are suitable for use in fat compositions that may be used as cocoa butter equivalents. They may also be used in confectionary products.

In yet another aspect, the invention relates to a fat composition comprising 30 to 80% of the inventive hard palm mid fraction and 20 to 70% of a StOSt-rich fat (viz. a fat rich in triacylglycerol having two stearic fatty acids on the 1 and 3 glycerol positions and one olein fatty acid on the 2 glycerol position), the StOSt-rich fat being selected from the group consisting of shea, illipe, kokum, sal, mango kernel, allanblackia, high stearic sunflower oil, enzymatically obtained StOSt-rich fat, fractions obtained thereof, and combinations of two or more thereof. Preferably the StOSt-rich fat is selected from the group consisting of shea, enzymatically obtained StOSt-rich fat, fractions obtained thereof and combinations of two or more thereof. More preferably the StOSt-rich fat is shea stearin.

In yet another aspect, the invention relates to a confectionary product comprising the soft palm mid fraction, the hard palm mid fraction or the fat composition according to the invention or a combination of two or more thereof, preferably wherein the confectionary product is selected from the group consisting of chocolate, a chocolate-like product, cocoa-based fillings and cocoa-based coatings.

In yet another aspect, the invention relates to the use of the fat composition of the invention as a CBE.

Below in the detailed description several preferred features are disclosed. Regardless of the aspect these features are disclosed for, these features are applicable to all of the aspects cited above and in the claims. These aspects of the invention address the needs discussed above.

### DETAILED DESCRIPTION

The present invention will be discussed below in more detail. All parameter ranges include the end-points of the ranges and all values in between the end-points, unless otherwise specified. When used in these specification and claims, the terms “comprises” and “comprising” and variations thereof mean that the specified features, steps or integers are included. The terms are not to be interpreted to exclude the presence of other features, steps or components. Unless otherwise defined or specified, all terms should be accorded a technical meaning consistent with the usual meaning in the art as understood by the skilled person.

### Process of the Invention

The process according to the present invention is a process for separation of a palm oil starting material into at least a stearin fraction and at least an olein fraction. The process according to the invention comprises at least two steps in which step b) is carried out after step a). Step a) is a step of short-path evaporation yielding a distillate and a retentate and step b) is a step of dry fractionation of the retentate yielding a stearin fraction and an olein fraction. Both of these steps are discussed in detail below. One or more additional steps may optionally be carried out prior to step a), in between step a) and step b) and/or after step b). These additional steps will be discussed below.

### Palm Oil Starting Material

As starting material in the process of the present invention, a so-called palm oil starting material is used. “Palm oil starting material” or “starting material” refers to either a palm oil or a palm oil component or one or more combinations thereof. “Palm oil component” refers to a palm oil fraction (viz. a fraction of palm oil obtained by single or multiple fractionation steps of palm oil) or one or more combinations thereof.

According to the invention, the palm oil starting material is selected from the group, consisting of palm oil, palm olein, palm stearin, soft stearin, and soft palm mid fraction and any combination of two or more thereof. More preferably, the palm oil starting material may be selected from the group consisting of palm olein, soft stearin, soft palm mid fraction, and any combination of two or more thereof. Most preferably, the palm oil starting material is selected from the group consisting of: i) a palm olein (IV 54-59), ii) a soft palm mid fraction (IV 42-48).

“Olein fraction” refers to a fraction obtained from fractionation that is liquid at the temperature of the fractionation step. Standard and known types of olein fractions are for example palm olein, superolein, top olein and soft stearin. Palm olein (IV 54-59) is the olein fraction of palm oil obtained after one fractionation step of palm oil. Superolein (IV 60-66) is the olein fraction obtained after a fractionation step starting from palm olein. Top olein (IV 70-73) is the olein fraction obtained after a fractionation step starting from superolein. Soft stearin (IV 40-42) is the olein fraction obtained after a fractionation step starting from hard stearin.

“Stearin fraction” refers to a fraction obtained from a fractionation that is solid at the temperature of the fractionation step. Standard and known types of stearin fractions are for example palm stearin, super stearin, and hard PMF. Palm stearin (IV 30-40) is the stearin fraction obtained after one fractionation step of palm oil. Super stearin (IV 17-21) is the stearin fraction obtained after a fractionation step starting from hard stearin. Hard PMF (IV 31-36) is the stearin fraction after a fractionation step starting from soft PMF.

Depending on the fractionation scheme used, soft PMF (IV 42-48) is either obtained as an olein fraction or as a stearin fraction. It may be the stearin fraction of a fractionation step starting from palm olein or it may be the olein fraction of a fractionation step starting from hard stearin. Typically, the soft PMF (IV 42-48) obtained according to a standard dry fractionation process is further characterized by an S2U content in between 60 and 68 wt. %, a DAG content of 8 wt. % or more and an S3 content of more than 7 wt. %.

### Pre-Treatment of Starting Material

The palm oil starting materials may be treated prior to step a) of the present process. This pre-treatment may be by means of one or more refining steps such as degumming, bleaching, and/or deodorization: the latter three are discussed below. The palm oil starting material is preferably a degummed, bleached and/or deodorized palm oil starting material. Preferably, the palm oil starting material is at least degummed.

Typically, a degummed, bleached and deodorized vegetable edible oil is known to be obtained by means of one of two major types of refining processes, i.e. a chemical or a physical refining process. The chemical refining process may typically comprise the major steps of degumming, alkali refining, also called neutralization, bleaching and deodorizing. The thus obtained deodorized oil is a chemically refined oil, also called “NBD” oil. Alternatively, the physical refining process may typically comprise the major steps of degumming, bleaching and deodorizing. A physically refining process is not comprising an alkali neutralization step as is present in the chemical refining process. The thus obtained deodorized oil is a physically refined oil, also called “RBD” oil.

Most preferably, the palm oil starting material in step a) is a physically refined oil (RBD oil).

An RBD oil is characterized by quality parameters, such as a low residual FFA content, a high oxidative stability, a light colour, and a neutral odour and taste. An RBD palm oil or palm oil component typically has a colour characterized by a Lovibond red colour of 3.5R or less, 3R or less and/or a Lovibond yellow colour of 35Y or less, 30Y or less (measured in a 5¼ inch glass measuring cell according to AOCS method Cc13e-92). Furthermore, the neutral odour and taste of an RBD palm oil or palm oil component is typically characterized by an overall flavour quality score (taste), according to AOCS method Cg 2-83, in a range of from 7 to 10, or from 8 to 10 or from 9 to 10 (with 10 being an excellent overall flavour quality score and 1 being the worst score).

### Degumming

Degumming is the process of eliminating impurities from vegetable oils, especially the elimination of phosphatides (so-called “gums”). Any of a variety of degumming processes known in the art may be used. One such process (known as “water degumming”) includes mixing water with the material to be degummed and separating the resulting mixture into an oil material and an oil-insoluble hydrated phosphatides component, sometimes referred to as “wet gum” or “wet lecithin”. Alternatively, phosphatide content can be reduced (or further reduced) by other degumming processes, such as acid degumming (using citric or phosphoric acid for instance), enzymatic degumming or chemical degumming. Alternatively, phosphatide content can also be reduced (or further reduced) by means of acid conditioning, wherein the oil is treated with acid in a high shear mixer and is subsequently sent without any separation of the phosphatides to the bleaching step.

### Bleaching

Bleaching is the process step whereby impurities are removed to improve the colour and flavour of the oil material to be bleached. It is typically performed prior to deodorization. The nature of the bleaching step will depend, at least in part, on the nature and quality of the oil being bleached. Generally, the oil material to be bleached will be mixed with a bleaching agent which combines, amongst others, with oxidation products, phosphatides, trace soaps, pigments and other compounds to enable their removal. The nature of the bleaching agent can be selected to match the nature of the crude or partially refined oil to yield a desirable bleached oil. Bleaching agents generally include natural or “activated” bleaching clays, also referred to as “bleaching earths”, activated carbon and various silicates. Natural bleaching agent refers to non-activated bleaching agents. They occur in nature or they occur in nature and have been cleaned, dried, milled and/or packed ready for use. Activated bleaching agent refers to bleaching agents that have been chemically modified, for example by activation with acid or alkali, and/or bleaching agents that have been physically activated, for example by thermal treatment. Activation includes the increase of the surface in order to improve the bleaching efficiency. Further, bleaching clays may be characterized based on their pH value. Typically, acid-activated clays have a pH value of 2.0 to 5.0. Neutral clays have a pH value of 5.5 to 9.0. A skilled person will be able to select a suitable bleaching agent from those that are commercially available based on the oil being refined and the desired end use of that oil.

The bleaching step for obtaining a bleached palm oil starting material that is subjected to the short-path evaporation in step a) of the process may be performed at a temperature of from 80 to 115° C., from 85 to 110° C., from 90 to 105° C., in the presence of neutral and/or natural bleaching earth in an amount of from 0.2 to 5%, from 0.5 to 3%, or from 0.7 to 1.5% based on amount of oil.

### Deodorizing

Deodorization is the process whereby free fatty acids (FFAs) and other volatile impurities are removed by treating (or “stripping”) a crude or partially refined oil under vacuum and at elevated temperature with sparge steam, nitrogen or other gasses. The deodorization process and its many variations and manipulations are well known in the art and the deodorization step of the present invention may be based on a single variation or on multiple variations thereof. For instance, deodorizers may be selected from any of a wide variety of commercially available system. The deodorizer may have several configurations, such as horizontal vessels or vertical tray-type deodorizers. Deodorization is typically carried out at elevated temperatures and reduced pressure to better volatilize the FFAs and other impurities. The precise temperature and pressure may vary depending on the nature and quality of the oil being processed. The pressure, for instance, will preferably be no greater than 0.0133 bar (10 mm Hg) but certain aspects of the invention may benefit from a pressure below or equal to 0.00667 bar (5 mm Hg), e.g. 0.0013-0.00533 bar (1-4 mm Hg). The temperature in the deodorizer may be varied as desired to optimize the yield and quality of the deodorized oil. At higher temperatures, reactions which may degrade the quality of the oil will proceed more quickly. For example, at higher temperatures, cis-fatty acids may be converted into their less desirable trans form. Operating the deodorizer at lower temperatures may minimize the cis-to-trans conversion, but will generally take longer or require more stripping medium or lower pressure to remove the requisite percentage of volatile impurities.

As such, deodorization is typically performed at a temperature of the oil in a range of 200 to 280° C., with temperatures of about 220-270° C. being useful for many oils. For cocoa butter, a deodorization temperature in a range of 130 to 220° C. is advised. Typically, deodorization is thus occurring in a deodorizer whereby volatile components such as FFAs and other unwanted volatile components that may cause off-flavours in the oil, are removed. Deodorization may also result in the thermal degradation of unwanted components.

The deodorization step for obtaining a deodorized palm oil starting material that is subjected to the short-path evaporation in step a) of the process may be performed at a temperature of from 200° C. to 270° C., from 210° C. to 260° C., or from 220° C. to 250° C. The deodorization step is taking place for a period of time from 30 min to 240 min, from 45 min to 180 min, or from 60 min to 150 min. The deodorization may be performed in the presence of sparge steam in a range of from 0.50 wt. % to 2.50 wt. %, from 0.75 wt. % to 2.00 wt. %, from 1.00 wt. % to 1.75 wt. %, or from 1.25 wt. % to 1.50 wt. % based on amount of oil, and at an absolute pressure of 10 mbar or less, 7 mbar or less, 5 mbar or less, 3 mbar or less, 2 mbar or less.

In a specific aspect, the palm oil starting material is degummed, bleached and deodorized prior to step a) of the claimed process: and it is obtainable by or directly obtained by the sequential steps of:

i) degumming to obtain a degummed palm oil or palm oil component:
ii) optionally alkali neutralizing the degummed palm oil or palm oil component from step i):
iii) bleaching the degummed palm oil or palm oil component from step i) or the alkali neutralized palm oil or palm oil component from step ii), preferably at a temperature of from 80 to 115° C., from 85 to 110° C., or from 90 105° C., preferably with neutral and/or natural bleaching earth in an amount of from 0.2 to 5%, from 0.5 to 3%, or from 0.7 to 1.5%, to obtain a degummed, optionally alkali neutralized, and bleached palm oil or palm oil component, and
iv) deodorizing the degummed, optionally alkali neutralized, and bleached palm oil or palm oil component from step iii), preferably at a temperature of from 200 to 270° C., from 210 to 260° C., or from 220 to 250° C., preferably for a period of time in a range of from 30 min to 240 min, from 45 min to 180 min, or from 60 min to 150 min, to obtain a deodorized, degummed, optionally alkali neutralized, and bleached palm oil or palm oil component, that is the palm oil starting material for step a) of the claimed process.

As a result of the oils being exposed to high temperatures during oil processing (=common refining process steps), especially during deodorization, contaminants such as GE and MCPD compounds are typically being formed.

The term monochloropropanediol compounds (MCPD) as used in the present description refers to MCPD compounds of 2-MCPD and 3-MCPD. These compounds will typically be esters of the MCPD with fatty acids. Analytical methods used for determining MCPDE also detect free MCPD as being part of the content of MCPD compounds. However, the free compounds are typically present in the oils at very low, even insignificant, levels.

Glycidyl esters (GE) are also typically present as esters of fatty acids. Analytical methods used for determining glycidyl esters also detect free glycidol as being part of the content of ester compounds. However, the free compounds are typically present in the oils at very low, even insignificant, levels.

For a deodorized palm oil starting material, the content of GE (glycidyl esters) in the starting material may be 1 ppm or more, 4 ppm or more, or even 10 ppm or more. For a deodorized palm oil starting material, the content of MCPD compounds in the starting material may be 2.0 ppm or more, 3 ppm or more, or even 4 ppm or more.

### Short-Path Evaporation

Step a) of the present process comprises subjecting a palm oil starting material to short-path evaporation.

Short-path evaporation, also called short-path distillation or molecular distillation or SPE, is a distillation technique that involves the distillate travelling a short distance, often only a few centimetres. SPE is preferably carried out at reduced operating pressure since that allows a decrease of boiling temperature to be obtained. SPE is a continuous process with a short residence time: it is often used for compounds which are unstable at high temperatures or to purify small amounts of compounds. The distillate only has to travel a short distance before condensing causing no additional pressure drop as it is the case in a typical distillate outlet line and thus allowing to work at lower pressure. Different types of short-path evaporation apparatus can be used that are well known to the skilled person. Preferably, the short-path evaporation of the process according to the invention is performed in a wiped film evaporation apparatus.

The short-path evaporation is performed at specific conditions of pressure and temperature.

The short-path evaporation is performed at a pressure below 1.0 mbar, preferably below 0.05 mbar, more preferably below 0.01 mbar, most preferably below 0.001 mbar.

The short-path evaporation is performed with an evaporator temperature of at least 230° C., in a range from 230 to 300° C., from more than 230 to 290° C., from 240° C. to 280° C. or even from 250° C. to 270° C.

Furthermore, the short-path evaporation is performed at a feed rate per unit area of evaporator surface of the shorth-path evaporation equipment. “Feed rate per unit area of evaporator surface of the shorth-path evaporation equipment”, also called “feed rate per unit area of evaporator surface”, “specific throughput” or “specific feed rate”, expressed in kg/h·m², is defined as the flow of starting material (expressed in kg/h) per unit area of evaporator surface of the SPE equipment (expressed in m²). The feed rate per unit area of evaporator surface in the process of the current invention is applicable to industrial short-path evaporation equipment independent of the dimensions of the equipment. Preferably, stainless steel short-path evaporation equipment is used for the current invention.

The short-path evaporation is preferably performed at a feed rate per unit area of evaporator surface of the shorth-path evaporation equipment in a range of from 5 to 180 kg/h·m², from 20 to 160 kg/h·m², from 40 to 140 kg/h·m².

In one aspect of the invention, the short-path evaporation is performed at a pressure of below 0.01 mbar, an evaporator temperature in a range of from 230° C. to 280° C. and at a feed rate per unit area of evaporator surface of the shorth-path evaporation equipment in a range of from 5 to 180 kg/h·m².

### Dry Fractionation

Step b) of the present process comprises subjecting the palm retentate obtained in step a) to a dry fractionation step to obtain a stearin fraction and an olein fraction.

Dry fractionation is a process to separate vegetable oils, such as palm oil, into two fractions, olein (fraction) and stearin (fraction), by the crystallization properties of the oils. By definition, dry fractionation takes place in the absence of solvents. The dry fractionation plant consists of crystallization section and filtration section. In the crystallization section preheated and oil obtained in step a) is fed into crystallizers and then cooled in a controlled environment to form crystals. The cooling sequence follows a defined program using programmable (logic) controllers that is known by persons skilled in the art. The slurry of crystals and oil is then pumped to the fractionation filter for separation of the solid crystals from the oil. In the filtration section, usually an automated membrane filter press is used for filtration of oil slurry to separate the solid crystals from the liquid fraction. The stearin fraction is retained as filter cake while the olein fraction passes through the filter as filtrate. Yield of the olein fraction may be maximized by squeezing the cake through inflation of the membrane with air or liquid.

For the process of the invention, the temperature conditions for dry fractionation in step b) of the process will be in line with temperature conditions applied for standard dry fractionation (without SPE prior to the fractionation) which are known to a person skilled in the art. Temperature set-points might be increased or decreased with 1 or 2° C. versus the standard temperature setting.

The process of the invention may comprise a step c), being subjecting the olein fraction or the stearin fraction obtained in step b) to one or more further dry fractionation steps to obtain further fractions.

### Additional Steps

In the process according to the present invention, additional steps may be present. The stearin fraction and/or the olein fraction obtained in step b) or step c) may be treated further. The additional treatment after step b) or c) may be a bleaching and/or a deodorization step.

### Effects of Invention

The process of the invention has been discussed in detail above. The effects of this inventive process are discussed here.

The present inventors have found that the purity of the fractions obtained was improved due to a better separation of the olein fraction from the stearin fraction. This is reflected in the triglyceride composition of these fractions.

The triglyceride composition of the obtained fractions is characterized by the amount of triglycerides of the type S3, S2U, SU2 and U3, wherein “S” refers to a saturated fatty acid with 16 to 20 carbon atoms and “U” refers to an unsaturated fatty acid with 18 carbon atoms. “S3” refers to a TAG (triglyceride, also called a triacylglycerol) having three saturated fatty acids. “S2U” refers to a TAG having two saturated fatty acids and one unsaturated fatty acid: an example thereof is StOSt referring to a TAG having two stearic fatty acids (saturated) on the 1 and 3 glycerol positions and one olein fatty acid (unsaturated) on the 2 glycerol position. “SU2” refers to a TAG having one saturated fatty acid and two unsaturated fatty acids. “U3” refers to a TAG having three unsaturated fatty acids.

The stearin fractions obtained using the process according to the present invention were found to contain an increased amount of S2U compared to a standard dry fractionation process. The stearin fractions obtained using the process according to the present invention may further contain less SU2 and U3 compared to a standard dry fractionation process.

The olein fractions obtained using the process according to the present invention were found to contain an increased amount of SU2 and U3 compared to a standard dry fractionation process. The olein fractions obtained using the process according to the present invention may further contain less S2U and S3 compared to a standard dry fractionation process.

This results in an improved, i.e. steeper, melting profile of the palm mid fractions which is indicative of a higher quality. The palm mid fractions obtained using the process according to the present invention were found to have a higher value of solid fat content (SFC) at 20° C. as well as a lower value of SFC at 35° C. compared to a palm mid fraction obtained through a standard dry fractionation process. SFC values for hard palm mid fraction (IV 31-36) were measured according to ISO 8292-1 of 2012 on fats stabilized at 26° C. for 40 h. For soft palm mid fraction (IV 42-48), the stabilization time and temperature of the ISO 8292-1 method was adapted to a stabilization at 20° C. for 24 h.

The present inventors have observed that the specific combination of selection specific starting materials as well as the SPE at higher temperature, viz. above 230° C., provides optical results regarding the removal of not only MCPD compounds but also the removal of DAG.

In addition to the improved separation and, as a result, an improved quality of the palm mid fractions, an increase yield of the palm mid fractions is obtained despite some material losses (distillate) during the SPE treatment.

The overall yield of the stearin fraction (soft PMF) according to the process according to the invention may be at least 25%, preferably at least 30%, more preferably at least 33%.

Furthermore, due to the lower S2U content of the olein fraction, the cold stability (at 4-7° C.) of the superolein and top olein obtained using the process according to the present invention were found to have improved.

Additionally, when a deodorized palm oil starting material is used, the process according to the present invention results in fractions with an improved quality in terms of triglyceride composition, as well as a low content in MCPD compounds and GE.

More specifically, when an RBD palm oil starting material is used, the process according to the present invention results in fractions with:

an improved quality in terms of triglyceride composition,
a low content in MCPD compounds (including MCPDE) and GE,
a light colour, characterized by a Lovibond red colour of 3.5R or less, 3R or less and/or a Lovibond yellow colour of 35Y or less, 30Y or less (measured in a 5¼ inch glass measuring cell according to AOCS method Cc13e-92), and
a neutral odour and taste, characterized by an overall flavour quality score (taste), according to AOCS method Cg 2-83, in a range of from 7 to 10, or from 8 to 10 or from 9 to 10 (with 10 being an excellent overall flavour quality score and 1 being the worst score).

### Specific Aspects of the Invention

In a specific aspect, the present invention relates to a separation process comprising the following steps in order:
step a) subjecting a palm olein (IV 54-59) to a short-path evaporation at a pressure below 1.0 mbar, at a temperature of at least 230° C. and at a feed rate per unit area of evaporator surface of the shorth-path evaporation equipment in a range of from 5 to 180 kg/h·m² to obtain a distillate and a palm retentate: and
step b) subjecting the palm retentate obtained in step a) to a dry fractionation step to obtain an olein fraction and a soft palm mid fraction (IV 42-48).

In another specific aspect, the present invention relates to a separation process comprising the following steps in order:
step a) subjecting a palm olein (IV 54-59) to a short-path evaporation at a pressure below 1.0 mbar, at a temperature of at least 230° C. and at a feed rate per unit area of evaporator surface of the shorth-path evaporation equipment in a range of from 5 to 180 kg/h·m² to obtain a distillate and a palm retentate:
step b) subjecting the palm retentate obtained in step a) to a dry fractionation step to obtain an olein fraction and a soft palm mid fraction (IV 42-48); and
step c) subjecting the soft palm mid fraction obtained in step b) to a further dry fractionation step to obtain an olein fraction and a hard palm mid fraction (IV 31-36).

In one more specific aspect, the present invention relates to a separation process for comprising the following steps in order:
step a) subjecting a soft palm mid fraction (IV 42-48) to a short-path evaporation at a pressure below 1.0 mbar, at a temperature of at least 230° C. and at a feed rate per unit area of evaporator surface of the shorth-path evaporation equipment in a range of from 5 to 180 kg/h·m² to obtain a distillate and a palm retentate; and
step b) subjecting the palm retentate obtained in step a) to a dry fractionation step to obtain an olein fraction and a hard palm mid fraction (IV 31-36).

### Blending

The process according to the invention may also include—be preceded or followed by—one or more blending steps.

In addition to the blending of starting materials and/or obtained fractions, one or more antioxidants may be blended with one or both of the fractions obtained. By the use of SPE, tocopherols present in the starting material will be removed into the distillate and are thus removed from the palm retentate. As a result, the end product might have a reduced oxidation stability: this can be solved by the blending/addition of anti-oxidants that are known in the art, e.g. butylated hydroxyanisole (BHA), butylated hydroxytoluene (BHT), propyl gallate (PG), tertiary-butylhydroquinone (TBHQ), citric acid, malic acid, succinic acid, tartaric acid, ascorbic acid, ascorbyl palmitate, erythorbic acid, carotenoids such as β-carotene, lycopene and lutein, synthetic tocopherols, plant extracts such as rosemary extract, green tea extract, carotenoids obtained from a natural source, lecithin, tocopherols, tocotrienols, phytosterols, phytostanols, olive oil phenolic compounds, phenolic compounds of sesam oil such, as sesamin, sesamol, sesamolin, sesaminol, sesamolinol, and the like.

Preferably, the fractions obtained by the process according to the invention may be blended with tocopherols, ascorbyl palmitate, lecithin or combinations of two or more thereof. Tocopherol may be recovered from the distillate obtained in step a) by an additional distillation step (preferably a second SPE step) starting from the distillate from the first SPE treatment: tocopherols may be recovered into the distillate stream and re-dosed into the oil fractions.

### Products Obtained by the Process

The present invention also relates to the products that are directly obtained by the processes of the invention. In particular, the invention relates to a soft palm mid fraction and a hard palm mid fraction obtainable by the process of the invention.

### Products According to the Invention

The present invention relates to a soft palm mid fraction having:
an iodine value in the range of 42 to 48;
   a content of triacylglycerol having two saturated fatty acids and one unsaturated fatty acid (S2U) in the range of 70 wt. % to 80 wt. %, preferably in the range of 72 wt. % to 78 wt. %;
a content of diacylglycerol (DAG) of less than 3.0 wt. %; preferably less than 2.5 wt. %, more preferably less than 2.0 wt. %;
a content of monochloropropanediol (MCPD) compounds of less than 1 ppm:
preferably a content of triacylglycerols having three saturated fatty acids (S3) of less than 6 wt. %, more preferably less than 5 wt. %; and
preferably a Lovibond red colour of 3.5R or less, preferably 3R or less (measured in a 5¼ inch glass measuring cell according to AOCS method Cc13e-92).

The present invention further relates to a hard palm mid fraction having:
an iodine value IV of 31 to 36:
a content of triacylglycerol having two saturated fatty acids and one unsaturated fatty acid (S2U) in the range of 80 wt. % to 95 wt. %, preferably in the range of 85 wt. % to 90 wt. %;
a content of diacylglycerol (DAG) of less than 3.0 wt. %; preferably less than 2.5 wt. %, more preferably less than 2.0 wt. %;
a content of monochloropropanediol (MCPD) compounds of less than 1 ppm: and
preferably a Lovibond red colour of 3.5R or less, preferably 3R or less (measured in a 5¼ inch glass measuring cell according to AOCS method Cc13e-92).

The hard palm mid fraction according to the invention may have a S2U to SU2 ratio (viz. ratio of triacylglycerol having two saturated fatty acids and one unsaturated fatty acid (S2U) to triacylglycerol having one saturated fatty acid and two unsaturated fatty acids (SU2)) of at least 8. The hard palm mid fraction may have a S3 content of at most 3.5 wt. %, preferably at most 2.0 wt. %. The hard palm mid fraction may have a SU2 content of at most 7.0 wt. %, preferably at most 5.0 wt. %. The hard palm mid fraction may have a solid fat content (SFC) at 35° C. of at most 5.0%, preferably at most 3.5%, preferably at most 2.0%. The SFC is measured according to ISO 8298-1 of 2012 as discussed above on a fat sample stabilized at 26° C. for 40 hours. The hard palm mid fraction may have a DAG content of less than 2.5 wt. %, preferably less than 2.0 wt. % The hard palm mid fraction may have an iodine value of IV of 32 to 34.

### Fat Composition and Use Thereof as Well as Confectionary Product

The present invention also relates to a fat composition comprising 30 to 80% of the hard palm mid fraction of the invention and 20 to 70% of a StOSt-rich fat (viz. a fat rich in triacylglycerol having two stearic fatty acids on the 1 and 3 glycerol positions and one olein fatty acid on the 2 glycerol position), the StOSt-rich fat being selected from the group consisting of shea, illipe, kokum, sal, mango kernel, allanblackia, high stearic sunflower oil, enzymatically obtained StOSt (triacylglycerol having two stearic fatty acids on the 1 and 3 glycerol positions and one olein fatty acid on the 2 glycerol position), fractions obtained thereof, and combinations of two or more thereof. Enzymatically obtained StOSt fat is obtained from a 1,3-specific enzymatic interesterification of high-oleic sunflower oil with stearic acid. Preferably the StOSt-rich fat is selected from the group consisting of shea, enzymatically obtained StOSt, fractions obtained thereof and combinations of two or more thereof. More preferably the StOSt-rich fat is shea stearin.

The present invention also relates to a fat composition comprising the hard palm mid fraction of the invention and at least one antioxidant, preferably tocopherols, ascorbylpalmitate, lecithin or combinations of two or more thereof.

In an aspect, the present invention relates to a confectionary product comprising the hard palm mid fraction of the invention or the fat composition according to the invention, preferably wherein the confectionary product is selected from the group consisting of chocolate or a chocolate-like product, cocoa-based fillings, cocoa-based coatings. “Chocolate-like product” refers to a product that resembles chocolate but contains fats that replace some or all of the cocoa butter compared to a chocolate containing cocoa butter as the sole fat. The confectionary product may, for example, be selected from bars and confectionery coatings.

Coatings may be applied to a confectionery or bakery product. The term “bakery products”, as used herein, refers to products that are typically produced or sold in a bakery and which have preferably been baked or fried, although they can be produced in other ways. The coating can be partial or complete and, when the coating is complete, the composition will encapsulate the bakery product. The bakery products are preferably made using flour. Examples of bakery products are donuts, cakes, biscuits, pastries and cookies.

Regarding the fat composition or confectionary product of the invention, the inventors found that the temperability of the palm mid fractions according to the present invention was improved; this contributes to better structuring properties combined with a better meltdown of the fat during eating thereof.

Although certain aspects of the invention have been described, the scope of the appended claims is not intended to be limited solely to these specific aspects.

### EXAMPLES

### Materials and Methods

### Palm Oil Starting Material

As starting material an RBD palm olein (IV of 54) was used, having a Lovibond red colour of less than 3.5 R and having a content of MCPD compounds of more than 2.0 ppm.

### Iodine Value

The iodine value is determined according to AOCS method Cd1c_85.

### Lovibond Colour Values

The Lovibond colour values are defined in red and yellow (R or Y) and are measured in a 5¼ inch glass measuring cell according to AOCS method Cc13e-92.

### Short-Path Evaporation

As SPE apparatus a laboratory wiped film SPE unit (KDL5 from UIC having an evaporator surface area of 0.48 m²) was used. The following conditions for SPE were applied:

i) a feed temperature of 70° C.;
ii) a condenser temperature of 80° C.;
iii) an evaporation temperature as indicated in Table 1;
iv) a wiper speed of 366 rpm;
v) an operating pressure as indicated in Table 1;
vi) a feed rate as indicated in Table 1.

TABLE 1
SPE conditions

| | Evaporation | Operating | | |
|---|---|---|---|---|
| | temperature | pressure | | Feed rate |
| SPE test 1 | 250° C. | 3.7 × 10⁻² | mbar | 0.36 l/h |
| SPE test 2 | 240° C. | <10⁻³ | mbar | 0.18 l/h |

Conversion of applied feed rates in KDL-5 SPE Unit (in liter/hour) to feed rate in a KD-10 industrial SPE Unit from IUC (in kg/h), and further conversion to the feed rate per unit area of evaporator surface of the shorth-path evaporation equipment (in kg/h·m²) for industrial scale short-path evaporation equipment is shown in Table 2.

TABLE 2
Conversion of applied feed rates

| | Feed rate per unit | |
|---|---|---|
| | area of evaporator | Feed rate per unit area of |
| | surface (in l/h · m2) | evaporator surface (in |
| | for KDL-5 short- | kg/h · m2) for industrial |
| Feed rate in KDL-5 | path evaporation | scale short-path |
| (in liter/h) | equipment | evaporation equipment |
| 0.18 l/h | 3.8 l/h · m² | 22.5 kg/h · m² |
| 0.36 l/h | 7.5 l/h · m² | 45 kg/h · m² |

Thus, the example is conducted according to the specifications of the claims.

### Dry Fractionation

The fat crystals were separated from the liquid oil in a filter press at a pressure of 30 bar.

### Product Obtained

The SFC (solid fat content) is measured according to ISO 8292-1 of 2012 after 24 h stabilization at 20° C.(for soft PMF) or after 40 h stabilization at 26° C. (for hard PMF).

### Example 1

### SPE Treatment

The starting material was subjected to step a) in an SPE apparatus using the conditions above. The retentate was obtained according to SPE test 1 (see table 1 above) in a yield of 82%. 18% of the starting material was removed in the form of the distillate. The composition of the starting material and retentate are shown in Table 3 below.

TABLE 3
composition before and after SPE treatment

| | Starting material | Retentate after SPE |
|---|---|---|
| Component | (wt. %) | (wt. %) |
| DAG | 12.9 | 1.7 |
| S3 | 2.4 | 3.3 |
| S2U | 49.2 | 56.6 |
| SU2 | 31.6 | 35.2 |
| U3 | 4.0 | 3.2 |
| TAG | 87.2 | 98.3 |
| Total | 100.0 | 100.0 |

### Dry Fractionation

Both the starting material (no SPE treatment—not according to the invention) as well as the retentate (SPE treatment—according to the invention) were subjected to dry fractionation. The non-treated starting material (not according to the invention) was crystallized at a final temperature of 16° C. The yield of the stearin fraction (soft PMF) was 24% and yield of the olein fraction (superolein) was 76%. The SPE treated material (according to the invention) crystallized much faster, it was crystallized at a final temperature of 18° C. (being 2° C. higher). The yield of the stearin fraction (soft PMF) was 41% and yield of the olein fraction (superolein) was 59%. When taking into account the yield loss of 18% during the SPE treatment, the overall yield of the stearin fraction (soft PMF) obtained according to the present invention was 34%, which is still significantly higher than for the non-treated material not according to the invention (34% vs 24%).

Table 4 below shows the composition of the materials not according to the invention, being: the starting material, the olein fraction (superolein 1) obtained from the starting material, and the stearin fraction (soft PMF 1) obtained from the starting material; as well as the materials according to the invention, being: the retentate, the olein fraction (superolein 2) obtained from the retentate, and the stearin fraction (soft PMF 2) obtained from the retentate.

TABLE 3
Composition after dry fractionation

| | Not according to the invention | | | | | |
|---|---|---|---|---|---|---|
| | Starting | | | According to the invention | | |
| | material | superolein 1 | soft PMF 1 | retentate | superolein 2 | soft PMF 2 |
| | (wt. %) | (wt. %) | (wt. %) | (wt. %) | (wt. %) | (wt. %) |
| S3 | 2.4 | 0.3 | 8.3 | 3.3 | 0.3 | 4.4 |
| S2U | 49.2 | 43.8 | 65.5 | 56.6 | 38.7 | 75.1 |
| SU2 | 31.6 | 37.5 | 12.6 | 35.2 | 52.1 | 17.7 |
| U3 | 4.0 | 4.5 | 1.6 | 3.2 | 6.6 | 2.0 |
| TAG | 87.2 | 86.1 | 88.0 | 98.3 | 97.7 | 99.2 |
| DAG | 12.9 | 13.9 | 12.0 | 1.7 | 2.4 | 0.8 |
| Total | 100.0 | 100.0 | 100.0 | 100.0 | 100.0 | 100.0 |

The soft PMF 2 according to the invention contains significantly more S2U (75.1 vs 65.5 wt. %) than the soft PMF 1 not according to the invention.

The difference in TAG composition between soft PMF1 and soft PMF2 is reflected in the steepness of the melting profile of these fats. This is demonstrated in Table 5. soft PMF2 shows a higher SFC at 20° C. and a lower SFC at 35° C. versus soft PMF 1, and thus a steeper melting profile which is beneficial for a palm mid fraction.

The obtained Soft PMF 1 and Soft PMF 2 were characterized by a Lovibond red colour of less than 3.5 R. Furthermore, the obtained Soft PMF 1 and Soft PMF 2 had a content of MCPD compounds of less than 1 ppm and a neutral odour and taste.

TABLE 5
SFC values for soft PMFs

| | PMF (1) | PMF (2) |
|---|---|---|
| | Not according to | According to |
| | the invention | the invention |
| SFC @ 20° C. (*) | 55.9% | 59.3% |
| SFC @ 35° C. (*) | 7.4% | 3.5% |

(*) SFC measured after stabilizing the fats at 20° C. for 24 hours

The superolein 2 according to the invention also has a lower amount of S2U (38.7 vs 43.8 wt. %), a higher amount of SU2 (52.1 vs 37.5 wt. %) as well as a higher amount of U3 (6.6 vs 4.5 wt. %) than the superolein 1 not according to the invention. This is desirable for cold stability of this liquid superolein for bottling applications. This example thus clearly shows the effect of the process of the present invention.

The above examples clearly show that one or more aims of the present invention are obtained by the process according to the present invention. The invention is now disclosed by the appended clauses and claims.

### CLAUSES

1. A separation process comprising the following steps, in order:

step a) subjecting a palm oil starting material to short-path evaporation at a pressure below 1.0 mbar, preferably below 0.05 mbar, more preferably below 0.01 mbar, most preferably below 0.001 mbar and at an evaporator temperature of at least 210° C., in a range from 210 to 300° C., from 220 to 290° C., from 230° C. to 280° C., to obtain a distillate and a palm retentate: preferably the palm oil starting material being selected from the group consisting of palm oil, palm olein, soft stearin, and soft palm mid fraction; and

step b) subjecting the palm retentate obtained in step a) to a dry fractionation step to obtain a stearin fraction and an olein fraction;

wherein said process optionally further comprises: step c) subjecting the stearin fraction or the olein fraction obtained in step b) to a further dry fractionation step to obtain further fractions; and
wherein said process optionally further comprises: step d) of subjection the stearin fraction or the olein fraction obtained in step b) or further fractions of step c) to a bleaching and/or deodorization step.
2. The process according to clause 1, wherein step a) is performed at a feed rate per unit area of evaporator surface of the shorth-path evaporation equipment in a range of from 5 to 180 kg/h·m², from 20 to 160 kg/h·m², from 40 to 140 kg/h·m².
3. The process according to clauses 1 or 2, comprising:

step a) subjecting an palm olein having a iodine value in the range of 54 to 59 to a short-path evaporation at a pressure below 1.0 mbar, at an evaporator temperature of at least 210° C. and at a feed rate per unit area of evaporator surface of the shorth-path evaporation equipment in a range of from 5 to 180 kg/h·m² to obtain a distillate and a palm retentate; and

step b) subjecting the palm retentate obtained in step a) to a dry fractionation step to obtain an olein fraction and a soft palm mid fraction having an iodine value in the range of 42 to 48.

4. The process according to clause 3, comprising a further step c) subjecting the soft palm mid fraction obtained in step b) to a further dry fractionation step to obtain an olein fraction and a hard palm mid fraction having an iodine value in the range of 31 to 36.
5. The process according to clauses 1 or 2, comprising:

step a) subjecting a soft palm mid fraction having a iodine value in the range of 42 to 48 to a short-path evaporation at a pressure below 1.0 mbar, at an evaporator temperature of at least 210° C. and at a feed rate per unit area of evaporator surface of the shorth-path evaporation equipment in a range of from 5 to 180 kg/h·m² to obtain a distillate and a palm retentate; and

step b) subjecting the palm retentate obtained in step a) to a dry fractionation step to obtain an olein fraction and a hard palm mid fraction having an iodine value in the range of 31 to 36.

6. A soft palm mid fraction obtainable by the process according to clause 3.
7. A soft palm mid fraction having:

an iodine value in the range of 42 to 48;

a S2U content in the range of 70 wt. % to 80 wt. %, preferably in the range of 72 wt. % to 78 wt. %;

a DAG content of less than 3.0 wt. %;

a MCPD compound content of less than 1 ppm; and

preferably an S3 content of less than 6%, more preferably less than 5%.

8. A hard palm mid fraction obtainable by the process according to clauses 4 or 5.
9. A hard palm mid fraction having:

an iodine value in the range of 31 to 36;

a S2U content in the range of 80 wt. % to 95 wt. %, preferably in the range of 85 wt. % to 90 wt. %;

a DAG content of less than 3.0 wt. %; and

a MCPD compound content of less than 1 ppm.

10. The hard palm mid fraction according to clause 8 or 9, having a S2U to SU2 ratio of at least 8 and/or a S3 content of at most 3.5 wt. %, preferably at most 2.0 wt. % and/or having a SU2 content of at most 7.0 wt. %, preferably at most 5.0 wt. %.
11. The hard palm mid fraction according to any one of clauses 8-10, having a solid fat content at 35° C. of at most 5.0%, preferably at most 3.5%, more preferably at most 2.0% measured on the hard palm mid fraction stabilized for 40 h at 26° C.
12. The hard palm mid fraction according to any one of clauses 8-11, having a DAG content of less than 2.5 wt. %, preferably less than 2.0 wt. % and/or having a iodine value in the range of 31 to 36, preferably in the range of 32 to 34.
13. A fat composition comprising 30 to 80% of the hard palm mid fraction according to any of claims 8-12 and 20 to 70% of a StOSt-rich fat, the StOSt-rich fat being selected from the group consisting of enzymatically obtained StOSt, shea, illipe, kokum, sal, mango kernel, allanblackia, high stearic sunflower oil, fractions obtained thereof, and combinations of two or more thereof; preferably the StOSt-rich fat is selected from the group consisting of enzymatically obtained StOSt, shea, fractions obtained thereof and combinations of two or more thereof; more preferably the StOSt-rich fat is shea stearin.
14. A confectionary product comprising the soft palm mid fraction according to clause 6 or 7, or the hard palm mid fraction according to any of clauses 8 to 12 or the fat composition according to clause 13 or a combination of two or more thereof, preferably wherein said confectionary product is selected from the group consisting of chocolate, a chocolate-like product, cocoa-based fillings and cocoa-based coatings.
15. Use of the fat composition according to clause 14 as a cocoa butter equivalent.

1. A separation process comprising the following steps, in order:
a) subjecting a palm oil starting material to short-path evaporation at a pressure below 1.0 mbar and at an evaporator temperature of at least 230° C., to obtain a distillate and a palm retentate; the palm oil starting material being selected from the group consisting of palm oil, palm olein, palm stearin, soft stearin, soft palm mid fraction and any combination of two or more thereof; and
b) subjecting the palm retentate obtained in a) to a dry fractionation step to obtain a stearin fraction and an olein fraction;
wherein the process optionally further comprises: c) subjecting the stearin fraction or the olein fraction obtained in b) to a further dry fractionation to obtain further fractions; and
wherein the process optionally further comprises: d) subjecting the stearin fraction or the olein fraction obtained in b) or further fractions of c) to bleaching and/or deodorization.

2. The process according to claim 1, wherein a) is performed at a feed rate per unit area of evaporator surface of the shorth-path evaporation equipment in a range of from 5 to 180 kg/h·m².

3. The process according to claim 1, comprising:
a) subjecting a palm olein having an iodine value in the range of 54 to 59 to a short-path evaporation at a pressure below 1.0 mbar, at an evaporator temperature of at least 230° C. and at a feed rate per unit area of evaporator surface of the shorth-path evaporation equipment in a range of from 5 to 180 kg/h·m² to obtain a distillate and a palm retentate; and
b) subjecting the palm retentate obtained in a) to dry fractionation to obtain an olein fraction and a soft palm mid fraction having an iodine value in the range of 42 to 48.

4. The process according to claim 3, further comprises c) subjecting the soft palm mid fraction obtained in b) to further dry fractionation to obtain an olein fraction and a hard palm mid fraction having an iodine value in the range of 31 to 36.

5. The process according to claim 1, comprising:
a) subjecting a soft palm mid fraction having an iodine value in the range of 42 to 48 to a short-path evaporation at a pressure below 1.0 mbar, at an evaporator temperature of at least 230° C. and at a feed rate per unit area of evaporator surface of the shorth-path evaporation equipment in a range of from 5 to 180 kg/h·m² to obtain a distillate and a palm retentate; and
b) subjecting the palm retentate obtained in a) to dry fractionation to obtain an olein fraction and a hard palm mid fraction having an iodine value in the range of 31 to 36.

6. A soft palm mid fraction having:
an iodine value in the range of 42 to 48;
a content of triacylglycerol having two saturated fatty acids and one unsaturated fatty acid (S2U) in the range of 70 wt. % to 80 wt. %;
a content of diacylglycerol (DAG) of less than 3.0 wt. %;
a content of monochloropropanediol (MCPD) compounds of less than 1 ppm;
a content of triacylglycerols having three saturated fatty acids (S3) of less than 6 wt. %; and
a Lovibond red value of 3.5R or less;
wherein the soft palm mid fraction is obtainable by the process according to claim 1.

7. A hard palm mid fraction having:
an iodine value in the range of 31 to 36;
a content of triacylglycerol having two saturated fatty acids and one unsaturated fatty acid (S2U) in the range of 80 wt. % to 95 wt. %;
a content of diacylglycerol (DAG) of less than 3.0 wt. %; and
a content of monochloropropanediol (MCPD) compounds of less than 1 ppm;
a Lovibond red value of 3.5R or less, more preferably 3R or;
wherein the hard palm mid fraction is obtainable by the process according to claim 1.

8. The hard palm mid fraction according to claim 7, having a ratio of triacylglycerol having two saturated fatty acids and one unsaturated fatty acid (S2U) to triacylglycerol having one saturated fatty acid and two unsaturated fatty acids (SU2) of at least 8 and/or a content of triacylglycerols having three saturated fatty acids (S3) of at most 3.5 wt. % and/or having a SU2 content of at most 7.0 wt. %.

9. The hard palm mid fraction according to claim 7, having a solid fat content at 35° C.of at most 5.0% measured on the hard palm mid fraction stabilized for 40 h at 26° C.

10. The hard palm mid fraction according to claim 7, having a content of diacylglycerol (DAG) of less than 2.5 wt. % and/or having an iodine value in the range of 31 to 36.

11. A fat composition comprising 30 to 80% of the hard palm mid fraction according to claim 7 and 20 to 70% of a fat rich in triacylglycerol having two stearin fatty acids on the 1 and 3 glycerol positions and one olein fatty acid on the 2 glycerol position (StOSt-rich fat), wherein the StOSt-rich fat being selected from the group consisting of shea, illipe, kokum, sal, mango kernel, allanblackia, high stearic sunflower oil, enzymatically obtained StOSt, fractions obtained thereof, and combinations of two or more thereof.

12. A confectionary product comprising the soft palm mid fraction according to claim 6, the hard palm mid fraction according to claim 7, the fat composition according to claim 11, or a combination of two or more thereof, wherein the confectionary product is selected from the group consisting of chocolate, a chocolate-like product, cocoa-based fillings and cocoa-based coatings.

13. (canceled)
